(19) United States
(12) Patent Application Publication
(10) Pub. No.: US 2012/0232793 A1
(43) Pub. Date: Sep. 13, 2012

(54) NAVIGATION SYSTEM AND ON-VEHICLE DEVICE

(75) Inventors: Masayuki Hagiwara, Kobe-shi (JP); Noriaki Inoue, Kobe-shi (JP); Toshio Kitahara, Kobe-shi (JP); Yoshiji Ishizuka, Kobe-shi (JP)

(73) Assignee: FUJITSU TEN LIMITED, Kobe-shi, Hyogo (JP)

(21) Appl. No.: 13/510,128

(22) PCT Filed: Aug. 5, 2010
(86) PCT No.: PCT/JP2010/063322

§ 371 Date: May 16, 2012

(30) Foreign Application Priority Data
Nov. 30, 2009 (JP) 2009-272866

(51) Int. Cl. G01C 21/28

(52) U.S. Cl. 701/518

(57) ABSTRACT

A navigation system is configured in which a driven distance calculating unit of an on-vehicle device calculates a first driven distance in a predetermined section based on vehicle speed calculated using vehicle speed pulses outputted from a vehicle and a vehicle speed calculation coefficient, a driven distance calculating unit of a portable terminal device calculates a second driven distance of the vehicle in the predetermined section based on GPS information provided from global navigation satellites, a learning unit corrects the vehicle speed calculation coefficient based on the result of comparing the first driven distance with the second driven distance, and a vehicle location predicting unit of the portable terminal device predicts a vehicle location based on the vehicle speed calculated using the vehicle speed pulses and the corrected vehicle speed calculation coefficient.

### FIELD

The present invention relates to a navigation system and an on-vehicle device that provide location information about a vehicle using the on-vehicle device and a portable terminal device, and more particularly to a navigation system and an on-vehicle device that can reduce a lag between a vehicle location displayed by the on-vehicle device and an actual vehicle location while preventing a reduction in the predictability of a vehicle location due to a change in the state of a vehicle.

### BACKGROUND

Conventionally, there is known a navigation system in which a portable terminal device is connected to an on-vehicle device in a wireless manner to communicate information with each other (in linking with each other), whereby a navigation function or a music reproduction function of the portable terminal device is used on the on-vehicle device side. Thus, it is made possible to intend to reduce the costs of the on-vehicle device.

However, in the aforementioned navigation system, communications between the portable terminal device and the on-vehicle device are performed using a relatively low-speed communication method such as Bluetooth (registered trademark), so that a vehicle location displayed on the on-vehicle device sometimes greatly lags behind an actual vehicle location due to communication delay. As described above, when the vehicle location displayed on the on-vehicle device lags behind the actual vehicle location, a problem arises because there is a possibility that a driver does not notice a place to make a turn and goes straight forward to deviate from a route, for example.

Therefore, in these years, various methods are proposed to solve the display lag of a vehicle location caused by such communication delay or the like. For example, Patent Literature 1 discloses a technique in which time required for receiving geographic information after sending a request for acquiring geographic information is estimated as delay time and the estimated delay time and vehicle speed are used to solve the display lag of a vehicle location. Here, an on-vehicle device in Patent Literature 1 calculates vehicle speed using vehicle speed pulses detected according to the rotation of a tyre.

### CITATION LIST

### Patent Literature

Patent Literature 1: Japanese Patent Application Laid-Open No. 2005-25037

### SUMMARY

### Technical Problem

However, the technique described in Patent Literature 1 has a problem in that the predictability of a vehicle location is reduced due to a change in the state of a vehicle. This is because the vehicle speed calculated using vehicle speed pulses sometimes lags behind actual vehicle speed due to a change in the state of the vehicle.

For example, in the case where the tyre diameter is changed because of a reduction in tyre pressure, the attachment of a tyre chain, or the like, the number of vehicle speed pulses outputted per unit driven distance is changed. Consequently, the vehicle speed obtained from the vehicle speed pulses sometimes lags behind actual vehicle speed. Moreover, in the case where tyres are distorted because of high speed driving, accurate vehicle speed sometimes cannot be calculated because vehicle speed pulses are irregularly outputted.

Therefore, even though the technique in Patent Literature 1 is used to estimate delay time, the on-vehicle device cannot be caused to display an accurate vehicle location if vehicle speed different from actual vehicle speed, that is, vehicle speed with large errors is used.

From these points, a large problem is how to implement a navigation system or an on-vehicle device that can reduce a lag between a vehicle location displayed by the on-vehicle device and an actual vehicle location while preventing a reduction in the predictability of a vehicle location due to a change in the state of a vehicle.

The present invention is made to solve the problem in the aforementioned conventional technique. It is an object to provide a navigation system and an on-vehicle device that can reduce a lag between a vehicle location displayed by the on-vehicle device and an actual vehicle location while preventing a reduction in the predictability of a vehicle location due to a change in the state of a vehicle.

### Solution to Problem

In order to solve the problem mentioned above and to attain the purpose, a navigation system that provides location information about a vehicle using an on-vehicle device and a portable terminal device, the navigation system comprising: a first calculating unit configured to calculate a driven distance in a predetermined section based on vehicle speed calculated using a vehicle speed pulse outputted from a vehicle and a vehicle speed calculation coefficient; a second calculating unit configured to calculate a driven distance by the vehicle in the predetermined section based on location information provided from a global navigation satellite; a correcting unit configured to correct the vehicle speed calculation coefficient based on a result of comparing the driven distance calculated by the first calculating unit with the driven distance calculated by the second calculating unit; and a predicting unit configured to predict a vehicle location based on the vehicle speed calculated using the vehicle speed pulse and the vehicle speed calculation coefficient corrected by the correcting unit.

And an on-vehicle device that provides location information about a vehicle in linking with a portable terminal device, the on-vehicle device comprising: a calculating unit configured to calculate a driven distance in a predetermined section based on vehicle speed calculated using a vehicle speed pulse outputted from a vehicle and a vehicle speed calculation coefficient; a correcting unit configured to correct the vehicle speed calculation coefficient based on a result of comparing the driven distance calculated by the calculating unit with a driven distance by the vehicle in the predetermined section calculated by the portable terminal device based on location information provided from a global navigation satellite; and a sending unit configured to send the vehicle speed calculation coefficient corrected by the correcting unit to the portable terminal device.

### Advantageous Effects of Invention

According to the present invention, the first calculating unit calculates a driven distance in a predetermined section based on vehicle speed calculated using a vehicle speed pulse outputted from the vehicle and the vehicle speed calculation coefficient, the second calculating unit calculates a driven distance by the vehicle in the predetermined section based on location information provided from a global navigation satellite, the correcting unit corrects the vehicle speed calculation coefficient based on the result of comparing the driven distance calculated by the first calculating unit with the driven distance calculated by the second calculating unit, and the predicting unit predicts a vehicle location based on the vehicle speed calculated using the vehicle speed pulse and the vehicle speed calculation coefficient corrected by the correcting unit. Thus, such effect is exerted that it is possible to reduce a lag between a vehicle location displayed by the on-vehicle device and an actual vehicle location while preventing a reduction in the predictability of a vehicle location due to a change in the state of a vehicle.

### BRIEF DESCRIPTION OF DRAWINGS

FIGS. 1(A) and 1(B) are diagrams illustrating the outline of a navigation method according to the present invention.

FIG. 2 is a block diagram illustrating the configurations of an on-vehicle device and a portable terminal device according to an embodiment.

FIG. 3 is a diagram for explaining learning levels.

FIG. 4 illustrates diagrams for explaining a learning section setting process performed by a learning section setting unit.

FIG. 5 is a diagram for explaining an error that occurs between a driven distance calculated based on GPS information and an actual driven distance.

FIGS. 6(A) to 6(C) illustrate diagrams for explaining the effect made by a navigation system according to the embodiment.

FIG. 7 is a sequence diagram illustrating process procedures between the on-vehicle device and the portable terminal device.

FIG. 8 is a sequence diagram illustrating different process procedures between the on-vehicle device and the portable terminal device.

### DESCRIPTION OF EMBODIMENTS

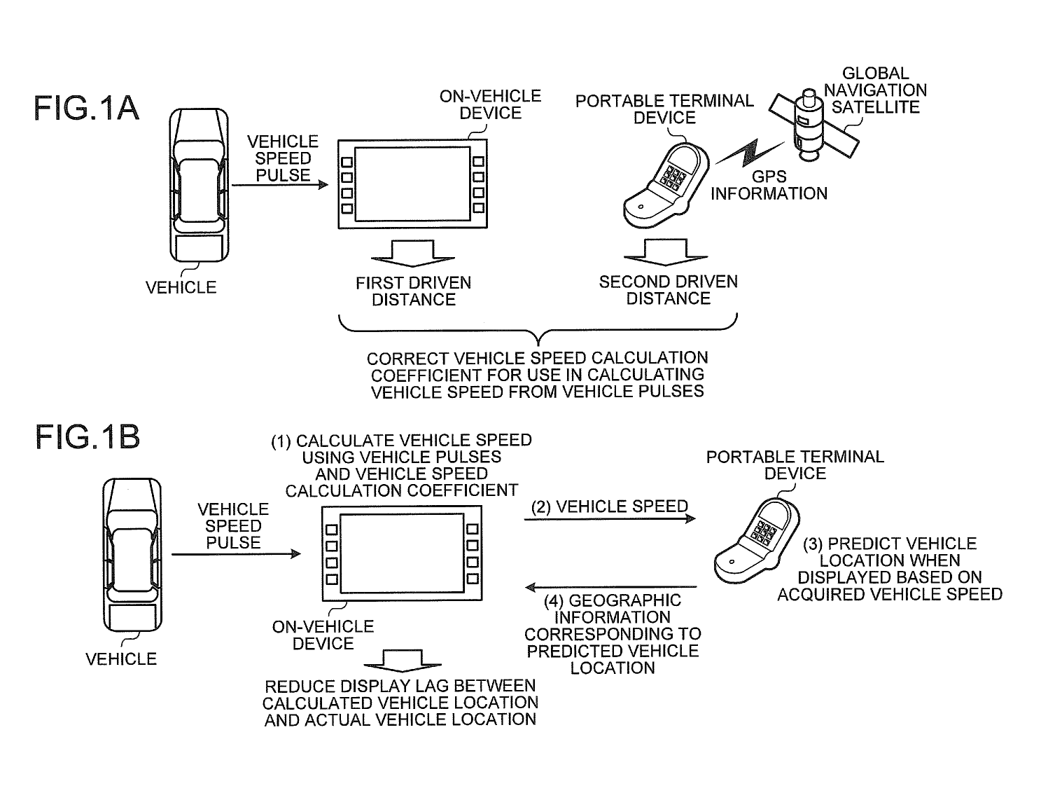

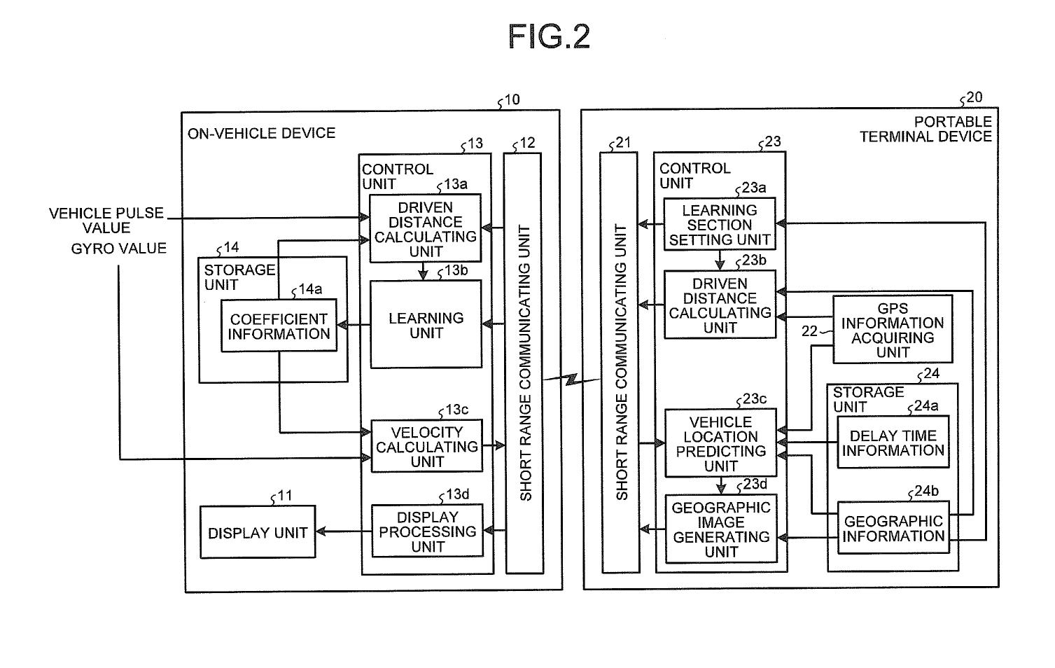

Hereinafter, an embodiment of a navigation system and an on-vehicle device, to witch a navigation method according to the present invention is applied, will be described in detail with reference to the accompanying drawings. It is noted that in the following, the outline of the navigation method according to the present invention will be described with reference to FIGS. 1(A) and 1(B), and then an embodiment of the navigation system, to which the navigation method according to the present invention is applied, will be described with reference to FIGS. 2 to 8.

First, prior to the detailed description of the embodiment, the outline of the navigation method according to the present invention will be described with reference to FIGS. 1(A) and 1(B). FIGS. 1(A) and 1(B) are diagrams illustrating the outline of the navigation method according to the present invention. As illustrated in FIGS. 1(A) and 1(B), the navigation method according to the present invention is characterized in that a driven distance calculated based on a vehicle speed calculation coefficient for use in calculating vehicle speed from vehicle speed pulses is compared with a driven distance calculated by different process procedures, thereby correcting the vehicle speed calculation coefficient.

Namely, in the navigation method according to the present invention, the vehicle speed calculation coefficient is corrected based on the result of comparing a first driven distance calculated based on vehicle speed pulses outputted from a vehicle with a second driven distance calculated based on location information and geographic information from global navigation satellites. In the navigation method according to the present invention, a vehicle location is then predicted using the vehicle speed pulses and the corrected vehicle speed calculation coefficient.

As illustrated in FIG. 1(A), in the navigation system according to the present invention, first, an on-vehicle device mounted on the vehicle calculates a driven distance by the vehicle in a predetermined section based on vehicle speed pulses. More specifically, the on-vehicle device calculates vehicle speed by multiplying the number of vehicle speed pulses outputted per unit time by the vehicle speed calculation coefficient, and calculates a driven distance by the vehicle (in the following, referred to as “a first driven distance”) by integrating the calculated vehicle speed.

Here, in the first driven distance calculated based on vehicle speed pulses, when the tyre diameter is changed due to a reduction in tyre pressure or high speed driving, the number of vehicle speed pulses outputted per unit time is changed. As a result, an error occurs between the first driven distance and an actual driven distance. Namely, the vehicle speed calculated based on vehicle speed pulses tends to cause an error between the calculated vehicle speed and the actual vehicle speed due to a change in the state of the vehicle.

Therefore, in the navigation system according to the present invention, suppose that a driven distance (in the following, referred to as “the second driven distance”) calculated based on location information acquired from global navigation satellites such as GPS (Global Positioning System) satellites (in the following, referred to as “GPS information”) is an actual driven distance and the vehicle speed calculation coefficient is corrected based on the result of comparing the actual driven distance with the first driven distance calculated based on vehicle speed pulses.

More specifically, the vehicle speed calculation coefficient is a coefficient that is obtained by multiplying a value converted from the vehicle speed pulse into vehicle speed (in the following, referred to as “a vehicle speed conversion value”) by a predetermined correction coefficient (in the following, referred to as “a vehicle speed correction coefficient”). In the navigation system according to the present invention, the vehicle speed correction coefficient is then corrected based on the result of comparing the first driven distance with the second driven distance, thereby correcting the vehicle speed calculation coefficient.

More specifically, in the navigation system according to the present invention, a portable terminal device carried by a driver calculates the second driven distance based on GPS information. Then, in the navigation system according to the present invention, a value obtained by dividing the second driven distance calculated based on GPS information by the first driven distance calculated based on vehicle speed pulses is considered to be a new vehicle speed correction coefficient, and the vehicle speed conversion value is multiplied by this new vehicle speed correction coefficient, thereby calculating a new vehicle speed calculation coefficient.

Thus, in the navigation system according to the present invention, vehicle speed can be calculated using a new vehicle speed calculation coefficient corresponding to a change in the state of the vehicle, so that it is possible to reduce an error between the calculated vehicle speed and the actual vehicle speed.

Then, in the navigation system according to the present invention, a vehicle location is predicted based on the vehicle speed calculated using the corrected vehicle speed calculation coefficient.

More specifically, as illustrated in FIG. 1(B), the on-vehicle device calculates vehicle speed using vehicle speed pulses outputted from the vehicle and the corrected vehicle speed calculation coefficient (see (1) in FIG. 1(B)), and sends the calculated vehicle speed to the portable terminal device (see (2) in FIG. 1(B)).

On the other hand, the portable terminal device predicts a vehicle location at a point in time when displayed by the on-vehicle device based on the acquired vehicle speed and delay time including communication delay between the on-vehicle device and the portable terminal device (see (3) in FIG. 1(B)). The portable terminal device then sends geographic information corresponding to the predicted vehicle location to the on-vehicle device (see (4) in FIG. 1(B)). Thus, the geographic information corresponding to the predicted vehicle location is displayed on the on-vehicle device, so that a display lag between the predicted vehicle location and the actual vehicle location is reduced.

As described above, in the navigation system according to the present invention, the vehicle location is predicted according to the vehicle speed calculated using the vehicle speed calculation coefficient corresponding to a change in the state of the vehicle, so that it is possible to prevent a reduction in the predictability of a vehicle location due to a change in the state of the vehicle. Consequently, it is possible to more surely reduce a display lag between the predicted vehicle location and the actual vehicle location.

It is noted that here, the case is described where the on-vehicle device calculates the first driven distance and the portable terminal device calculates the second driven distance. However, the embodiment is not limited thereto. Such a configuration may be possible in which the portable terminal device calculates the first driven distance and the second driven distance. In this case, it is sufficient that the on-vehicle device sends vehicle speed pulses acquired from the vehicle to the portable terminal device and the portable terminal device calculates the first driven distance based on the vehicle speed pulses acquired from the on-vehicle device. Moreover, the on-vehicle device calculates the vehicle speed calculation coefficient. However, this processing may be performed on the portable terminal device side.

Furthermore, here, the case is described where only the vehicle speed calculation coefficient is corrected. However, the navigation system according to the present invention can also correct an angular velocity calculation coefficient for use in calculating angular velocity from the output value of a gyro sensor mounted on the vehicle. Here, the angular velocity calculation coefficient is a coefficient obtained by multiplying a value converted from the output value of the gyro sensor into angular velocity (in the following, referred to as “an angular velocity converted value”) by a predetermined correction coefficient (in the following, referred to as “an angular velocity correction coefficient”). Then, in the navigation system according to the present invention, the angular velocity correction coefficient is corrected to correct the angular velocity calculation coefficient. The detail of these points will be described later in an embodiment.

In the following, an embodiment of a navigation system and an on-vehicle device, to which the navigation method described with reference to FIGS. 1(A) and 1(B) is applied, will be described in detail. It is noted that in the following, a navigation system will be described in which an on-vehicle device and a portable terminal device are linked with each other, whereby the GPS function and navigation function of the portable terminal device are used the on-vehicle device side.

### EMBODIMENT

FIG. 2 is a block diagram illustrating the configurations of an on-vehicle device and a portable terminal device according to this embodiment. It is noted that FIG. 2 illustrates only components necessary to describe the features of an on-vehicle device 10 and a portable terminal device 20 and the description of typical components is omitted.

As illustrated in FIG. 2, the on-vehicle device 10 includes a display unit 11, a short range communicating unit 12, a control unit 13, and a storage unit 14. Moreover, the control unit 13 includes a driven distance calculating unit 13a, a learning unit 13b, a velocity calculating unit 13c, and a display processing unit 13d. The storage unit 14 stores coefficient information 14a.

On the other hand, the portable terminal device 20 includes a short range communicating unit 21, a GPS information acquiring unit 22, a control unit 23, and a storage unit 24. Furthermore, the control unit 23 includes a learning section setting unit 23a, a driven distance calculating unit 23b, a vehicle location predicting unit 23c, and a geographic image generating unit 23d. The storage unit 24 stores delay time information 24a and geographic information 24b.

In the following, first, the components of the on-vehicle device 10 will be described. The display unit 11 is a display device such as a display that displays various images. The short range communicating unit 12 establishes a communication link to the portable terminal device 20 using short range wireless communications such as Bluetooth (registered trademark), and processes communications between the on-vehicle device 10 and the portable terminal device 20 using the established communication link. Here, Bluetooth (registered trademark) refers to a short range wireless communication standard for wireless communications in a radius of about a few tens meters using a frequency band of 2.4 GHz. In these years, Bluetooth is widely applied to electronic devices such as a mobile telephone and a personal computer.

It is noted that in this embodiment, the case will be described where Bluetooth (registered trademark) is used for communications between the on-vehicle device 10 and the portable terminal device 20. However, such a configuration may be possible to use other wireless communication standards such as Wi-Fi (registered trademark) and ZigBee (registered trademark). Moreover, such a configuration may be possible to provide communications between the on-vehicle device 10 and the portable terminal device 20 through cable communications.

The control unit 13 is a processing unit that executes processing such as calculation processing for the driven distance, correction processing for the vehicle speed calculation coefficient, the angular velocity calculation coefficient, or the like, calculation processing for vehicle speed and angular velocity, and display processing for geographic images.

The driven distance calculating unit 13a is a processing unit that calculates a driven distance in a predetermined section (in the following, referred to as “a learning section”) based on vehicle speed calculated using vehicle speed pulses outputted from the vehicle and the vehicle speed calculation coefficient. More specifically, the driven distance calculating unit 13a measures vehicle speed from the reception of an instruction to start learning from the portable terminal device 20 to the reception of an instruction to end learning, and calculates a driven distance by the vehicle by integrating the measured vehicle speed. It is noted that the driven distance calculating unit 13a calculates vehicle speed by multiplying the number of vehicle speed pulses outputted per unit time by the vehicle speed calculation coefficient stored as the coefficient information 14a in the storage unit 14.

Moreover, the driven distance calculating unit 13a is also a processing unit that calculates an angular variation in the learning section based on angular velocity calculated using the output value of the gyro sensor mounted on the vehicle and the angular velocity calculation coefficient. More specifically, the driven distance calculating unit 13a measures angular velocity from the reception of an instruction to start learning from the portable terminal device 20 to the reception of an instruction to end learning, and calculates an angular variation in the vehicle by integrating the measured angular velocity. It is noted that the driven distance calculating unit 13a calculates angular velocity by multiplying a difference between the output value of the gyro sensor and a gyro offset value outputted in the state in which the vehicle does not rotates by the angular velocity calculation coefficient stored as the coefficient information 14a in the storage unit 14.

The learning unit 13b is a processing unit that corrects the vehicle speed calculation coefficient based on the result of comparing the first driven distance calculated by the driven distance calculating unit 13a with the second driven distance calculated by the portable terminal device 20 based on GPS information. More specifically, the learning unit 13b considers a value obtained by dividing the second driven distance by the first driven distance to be a new vehicle speed correction coefficient, and multiplies the vehicle speed conversion value by this new vehicle speed correction coefficient, thereby calculating a new vehicle speed calculation coefficient. The learning unit 13b then updates the vehicle speed calculation coefficient already stored in the storage unit 14 by the newly calculated vehicle speed calculation coefficient. It is noted that the vehicle speed conversion value is supposed to be stored in the storage unit 14.

Furthermore, the learning unit 13b is also a processing unit that corrects the angular velocity calculation coefficient based on the result of comparing an angular variation calculated by the driven distance calculating unit 13a (in the following, referred to as “a first angular variation”) with an angular variation calculated by the portable terminal device 20 based on GPS information (in the following, referred to as “a second angular variation”). More specifically, the learning unit 13b considers a value that the second angular variation is divided by the first angular variation to be a new angular velocity correction coefficient, and multiplies the angular velocity converted value by this new angular velocity correction coefficient, thereby calculating a new angular velocity calculation coefficient. The learning unit 13b then updates the angular velocity calculation coefficient already stored in the storage unit 14 by the newly calculated angular velocity calculation coefficient. It is noted that the angular velocity converted value is supposed to be stored in the storage unit 14.

It is noted that the learning unit 13b also processes learning the number of vehicle speed pulses outputted per tyre turn based on GPS information. For example, the learning unit 13b measures the number of vehicle speed pulses outputted in the learning section, and calculates a driven distance per pulse using a driven distance in the same section acquired from the portable terminal device 20. The learning unit 13b then divides the driven distance per tyre turn stored beforehand by the calculated driven distance per pulse, thereby calculating the number of vehicle speed pulses per tyre turn.

Moreover, the learning unit 13b also learns the gyro offset value. For example, the learning unit 13b calculates the output value in a state in which the vehicle stops (in a state in which the output of the gyro sensor is theoretically zero) as the gyro offset value. It is noted that such a configuration may be possible in which the learning unit 13b acquires geographic information or GPS information from the portable terminal device 20 and learns the gyro offset value in driving in the case of determining that the vehicle is traveling straight using the acquired geographic information or GPS information.

The learning unit 13b stores the learned number of vehicle speed pulses per tyre turn (in the following, referred to as “a pulse system”) and the gyro offset value as the coefficient information 14a in the storage unit 14.

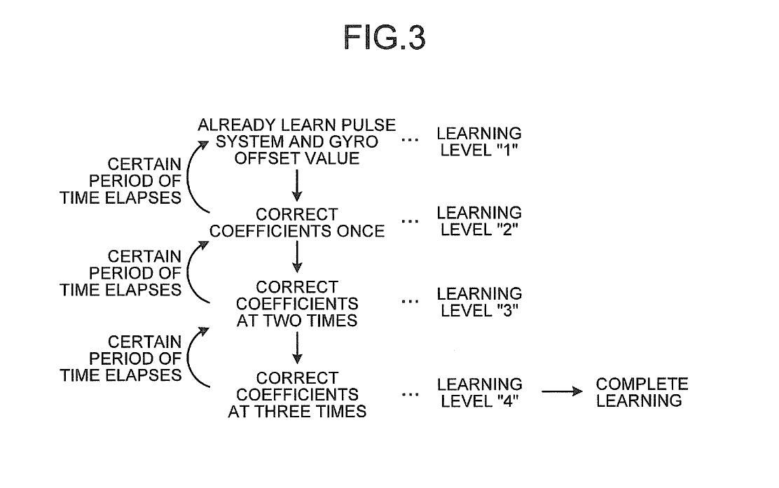

Furthermore, the learning unit 13b calculates the vehicle speed calculation coefficient, the angular velocity calculation coefficient, the vehicle speed pulse system, or the gyro offset value, and then notifies a learning level indicating the learning situations of the device to the portable terminal device 20. Here, this learning level will be described. FIG. 3 is a diagram for explaining learning levels.

As illustrated in FIG. 3, the learning unit 13b calculates the vehicle speed calculation coefficient, the angular velocity calculation coefficient, the vehicle speed pulse system, or the gyro offset value step by step. More specifically, the learning unit 13b learns the pulse system and the gyro offset value, and then notifies a learning level “1” to the portable terminal device 20. Similarly, when the learning unit 13b corrects the vehicle speed calculation coefficient and the angular velocity calculation coefficient once, the learning unit 13b notifies a learning level “2” to the portable terminal device 20, a learning level “3” when correcting the coefficients at two times, and a learning level “4” when correcting the coefficients at three times.

Then, in the case where the learning level reaches the level “4”, learning is completed, and vehicle speed and angular velocity are calculated using the vehicle speed calculation coefficient, the angular velocity calculation coefficient, or the like at a point in time when learning is completed.

On the other hand, when a certain period of time elapses after learning is completed, the learning unit 13b lowers the learning level in one stage, and sends the learning level “3” to the portable terminal device 20. Similarly, the learning unit 13b lowers the learning level from “2” to “1” and to “0” for every time when a certain period of time elapses.

As described above, the learning level is to be lowered by one stage for every time when a certain period of time elapses. The learning unit 13b again performs learning processing for every time when the learning level is lowered, and stores a new vehicle speed calculation coefficient, a new angular velocity calculation coefficient, or the like corresponding to a change in the state of the vehicle as the coefficient information 14a. It is noted that in the case where different learning timing arrives before a certain period of time elapses, learning processing is restarted accordingly. Moreover, in the case where the pulse system is changed (for example, in the case where the on-vehicle device is mounted on a different vehicle), the learning level becomes the learning level “0”, and learning is again performed from the beginning even though the learning level is at any level.

It is noted that the learning unit 13b calculates a difference between sending time stored in the storage unit 14 by the velocity calculating unit 13c, described later, and reception completion time of a geographic image notified by the display processing unit 13d as delay time, and sends the calculated delay time to the portable terminal device 20 via the short range communicating unit 12.

It is noted that such a configuration may be possible in which the learning unit 13b stores the calculated delay time in the storage unit 14 without sending the calculated delay time to the portable terminal device 20 and corrects the calculated vehicle speed calculation coefficient using the delay time stored in the storage unit 14 in the case of calculating the vehicle speed calculation coefficient.

The velocity calculating unit 13c is a processing unit that calculates vehicle speed by multiplying the number of vehicle speed pulses per unit time by the vehicle speed calculation coefficient stored as the coefficient information 14a in the storage unit 14. Moreover, the velocity calculating unit 13c calculates angular velocity by multiplying a difference between the output value of the gyro sensor and the gyro offset value outputted in the state in which the vehicle does not rotates by the angular velocity calculation coefficient stored as the coefficient information 14a in the storage unit 14. Furthermore, the velocity calculating unit 13c sends the calculated vehicle speed and the calculated angular velocity to the portable terminal device 20 via the short range communicating unit 12. In addition, the velocity calculating unit 13c stores the sending time of vehicle speed and the angular velocity in the storage unit 14.

It is noted that here, the driven distance calculating unit 13a measures vehicle speed from the reception of an instruction to start learning to the resection of an instruction to end learning. However, such a configuration may be possible in which the velocity calculating unit 13c stores the history of vehicle speed in this section in the storage unit 14. In this case, it is sufficient that the driven distance calculating unit 13a fetches the history of vehicle speed from the storage unit 14 to calculate the first driven distance from the fetched history.

The display processing unit 13d is a processing unit that displays a geographic image acquired from the portable terminal device 20 through the short range communicating unit 12 on the display unit 11. Moreover, the display processing unit 13d notifies the reception time of geographic information to the learning unit 13b.

Next, the configuration of the portable terminal device 20 will be described. As similar to the short range communicating unit 12 of the on-vehicle device 10, the short range communicating unit 21 establishes a communication link to the on-vehicle device 10 using short range wireless communications such as Bluetooth (registered trademark), and processes communications between the portable terminal device 20 and the on-vehicle device 10 using the established communication link. The GPS information acquiring unit 22 is a device that acquires GPS information including location information provided from GPS satellites. It is noted that this GPS information may include the acquisition time or the like of GPS information in addition to location information.

The control unit 23 is a processing unit that performs processing such as a learning section setting process, calculation processing for the second driven distance, the prediction of a vehicle location, and the generation of geographic images. It is noted that the control unit 23 also performs processing for storing the received delay time as the delay time information 24a in the storage unit 24 in the case of receiving delay time from the on-vehicle device 10 via the short range communicating unit 21.

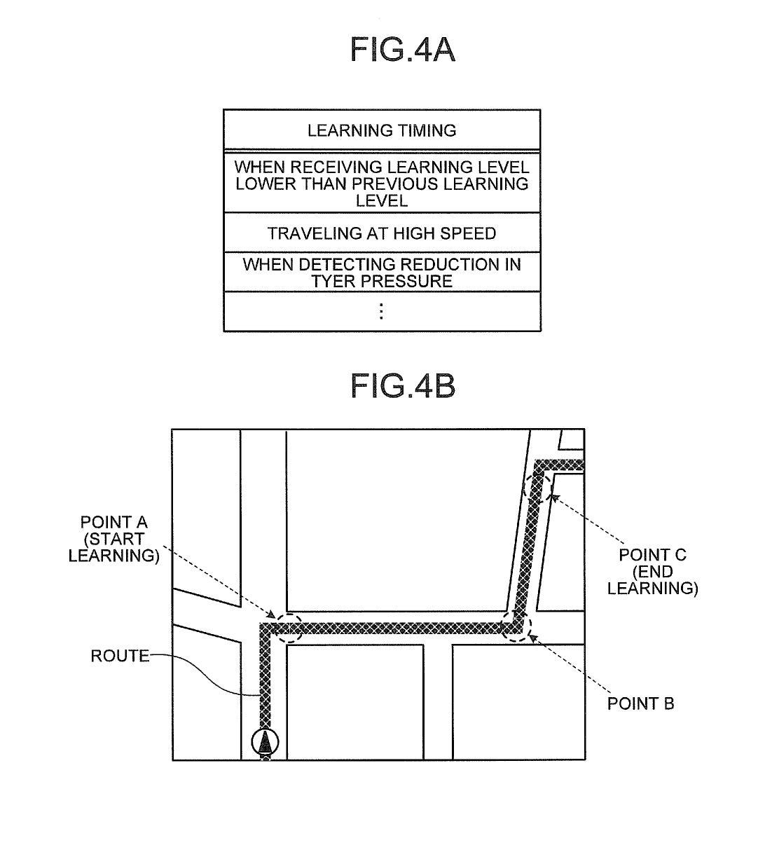

The learning section setting unit 23a is a processing unit that sets a section suited for calculating a driven distance and an angular variation to a learning section based on GPS information and geographic information in the case of determining that learning timing arrives. Here, the learning section setting process performed by the learning section setting unit 23a will be described. FIG. 4 illustrates diagrams for explaining the learning section setting process performed by the learning section setting unit 23a. It is noted that FIG. 4(A) illustrates exemplary learning timing, and FIG. 4(B) illustrates an exemplary learning section.

The learning section setting unit 23a sets a learning section in the case of determining that learning timing arrives as illustrated in FIG. 4(A). For example, the learning section setting unit 23a determines that learning timing arrives in the case of receiving a learning level lower than the previously received learning level from the on-vehicle device 10 (for example, in the case of receiving the learning level “3” after receiving the learning level “4”). This is because a certain period of time elapses after the previous learning and it is likely that the vehicle speed calculation coefficient and the angular velocity calculation coefficient do not match with the present state of the vehicle.

Moreover, the learning section setting unit 23a determines that learning timing arrives in the case where the vehicle is traveling at high speed. This is because tyres are distorted due to high speed driving and vehicle speed pulses are irregularly outputted, so that it is unlikely to calculate accurate vehicle speed.

For example, it is sufficient that the learning section setting unit 23a determines that the vehicle is traveling at high speed in the case of detecting that the vehicle is located on an expressway using geographic information and GPS information. Furthermore, the learning section setting unit 23a may determine that the vehicle is traveling at high speed in the case where the vehicle speed acquired from the velocity calculating unit 13c of the on-vehicle device 10 is at a predetermined velocity or more (for example, 80 km/h).

In addition, the learning section setting unit 23a determines that learning timing arrives in the case of detecting a reduction in tyre pressure. This is because a reduction in tyre pressure causes to change the tyre diameter and to change the number of vehicle speed pulses outputted per unit driven distance. As a result, it is likely that the vehicle speed obtained from the vehicle speed pulses lags behind actual vehicle speed.

For example, the learning section setting unit 23a detects a reduction in tyre pressure in the case where the on-vehicle device 10 notifies that the tyre pressure takes a predetermined value or less. It is noted that the on-vehicle device 10 acquires the tyre pressure of the vehicle from a tyre pressure detector, not shown, mounted on the vehicle and sends the tyre pressure to the portable terminal device 20. This tyre pressure detector is a device that is built in individual tyres and detects the air pressure of the tyres using a pressure sensor or the like.

The learning section setting unit 23a determines that learning timing arrives as described above, and then sets a section suited for calculating a driven distance and an angular variation in scheduled traveling sections for the vehicle as a learning section using route information set by the driver.

For example, as illustrated in FIG. 4(B), the learning section setting unit 23a sets a point A as a learning start point, and sets a point C as a learning end point in the scheduled traveling sections of the vehicle. Here, the point A is a point at which the vehicle finishes turning right at an intersection, and the point C is a point at which immediately before the vehicle turns right at a different intersection. Moreover, the section between the point A and the point C is a flat section with few slopes, and there is a corner (a point B) in the midway of the section. As described above, the learning section setting unit 23a sets a learning section under the conditions that an angle in the yaw direction is changed only in one direction and a tilt angle to the horizontal plane ranges within a predetermined threshold.

Namely, in the case where an angular variation is calculated in a section where an angle in the yaw direction is changed in the lateral direction like an S-curve, the accuracy of calculating an angular variation tends to be low as compared with the case where an angular variation is calculated in a section where an angle in the yaw direction is changed only in one direction. Therefore, as illustrated in FIG. 4(B), the learning section setting unit 23a sets a section where an angle in the yaw direction is changed only in one direction as a learning section, whereby an angular variation can be appropriately calculated.

It is noted that if the learning section setting unit 23a sets a section where an angle in the yaw direction is changed once as a learning section, that is, a section where an angular variation in the yaw direction exists at one place, not a section where an angle in the yaw direction is changed at multiple times, whereby the accuracy of calculating an angular variation by the driven distance calculating units 13a and 23b can be further enhanced.

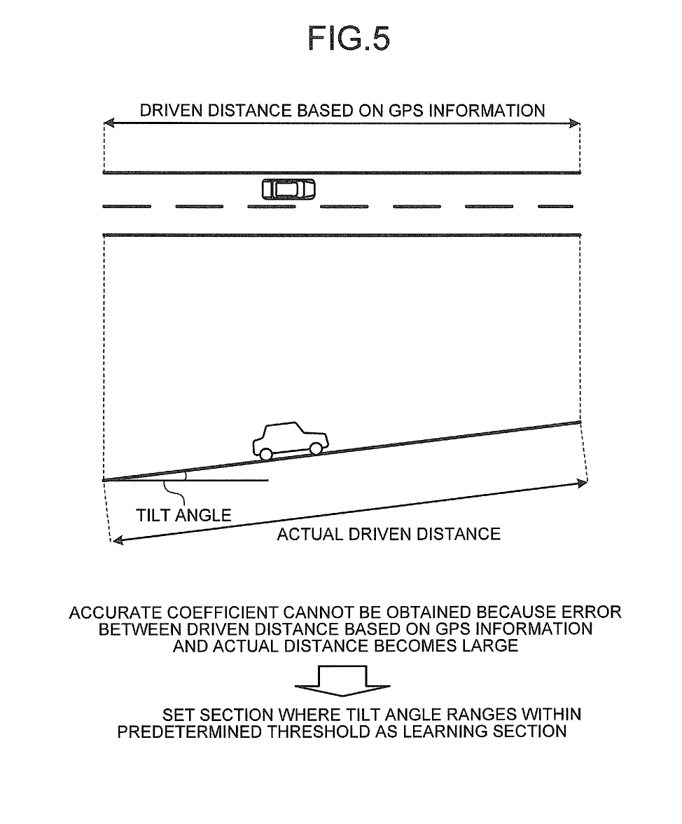

Moreover, desirably, the learning section is a flat section with few slopes. This point will be described with reference to FIG. 5. FIG. 5 is a diagram for explaining an error that occurs between a driven distance calculated based on GPS information and an actual driven distance.

As illustrated in FIG. 5, since a driven distance based on GPS information is calculated accruing to a flat distance between the learning start point and the learning end point, a difference in the altitude of the section is not taken into account. Therefore, in the case where a section with slopes is set as a learning section, an error between a driven distance calculated based on GPS information and an actual distance becomes large, and the accurate vehicle speed calculation coefficient and the accurate angular velocity calculation coefficient cannot be acquired.

Therefore, the learning section setting unit 23a sets a section where a tilt angle to the horizontal plane ranges within a predetermined threshold as a learning section, thereby reducing an error between a driven distance calculated based on GPS information and an actual driven distance. More specifically, if altitude information is included in the geographic information 24b stored in the storage unit 24, the learning section setting unit 23a uses this altitude information to identify a section where a tilt angle to the horizontal plane ranges within a predetermined threshold. Thus, it is possible to enhance the accuracy of correcting the vehicle speed calculation coefficient and the angular velocity calculation coefficient.

It is noted that the learning section setting unit 23a may correct a driven distance calculated based on GPS information to a driven distance in consideration of a difference in altitude in the case where geographic information includes altitude information. With this correction, it is unnecessary to exclude sections with slopes from learning sections, so that it is possible to widen options of selecting learning sections.

On the other hand, in the case of determining that the vehicle is located on an expressway, the learning section setting unit 23a sets a section on the expressway as a learning section. Thus, in the case where the vehicle enters an expressway, the vehicle speed calculation coefficient and the angular velocity calculation coefficient, which are presently used, can be switched to a vehicle speed calculation coefficient and an angular velocity calculation coefficient suited for high speed driving. It is noted that the learning section setting unit 23a sets a learning section also in the case where the vehicle exits from the expressway. Thus, it is possible to return the vehicle speed calculation coefficient and the angular velocity calculation coefficient corrected for high speed driving to the vehicle speed calculation coefficient and the angular velocity calculation coefficient suited for normal driving.

It is noted that when the vehicle reaches the point A, the learning section setting unit 23a sends an instruction to start learning to the driven distance calculating unit 13a, and instructs the driven distance calculating unit 23b to start learning. Moreover, when the vehicle reaches the point C, the learning section setting unit 23a sends an instruction to end learning to the driven distance calculating unit 13a, and instructs the driven distance calculating unit 23b to end learning. Thus, the driven distance calculating unit 13a is to calculate a driven distance and an angular variation between the point A and the point C based on vehicle speed pulses and the output value of the gyro sensor. Furthermore, the driven distance calculating unit 23b is to calculate a driven distance and an angular variation between the point A and the point C based on GPS information and geographic information.

Now, here, the case is described where the driven distance calculating unit 13a of the on-vehicle device 10 and the driven distance calculating unit 23b of the portable terminal device 20 calculate a driven distance and an angular variation only in the section set to the learning section. However, the embodiment is not limited thereto. For example, such a configuration may be possible in which the driven distance calculating units 13a and 23b always calculate a driven distance and an angular variation and accumulate the calculated results in the storage unit 14 and the learning section setting unit 23a corrects the vehicle speed calculation coefficient and the angular velocity calculation coefficient afterward using the accumulated calculated results.

More specifically, in the case of determining that learning timing arrives, the learning section setting unit 23a sets a section suited for calculating a driven distance and an angular variation to a learning section afterward in sections where the driven distance calculating units 13a and 23b have calculated a driven distance and an angular variation. With this setting, as compared with the case where a learning section is set after determining that learning timing arrives, it is possible to more quickly correct the vehicle speed calculation coefficient and the angular velocity calculation coefficient. Moreover, the section where the vehicle already passes is set to a learning section, so that it is possible to perform learning processing also in the case where the driver does not set route information.

It is noted that in the case where the gyro sensor mounted on the vehicle is a three-axis gyro sensor to measure three-dimensional rotational motions, the learning section setting unit 23a can identify the altitude of the section where the vehicle already passes using the three-axis gyro sensor. Thus, also in the case where geographic information does not include altitude information, it is possible to set a learning section afterward to sections with slopes.

Furthermore, the learning section setting unit 23a calculates a driven distance and an angular variation using the same learning section. However, a learning section may be set for every driven distance and every angular variation. For example, in the case illustrated in FIG. 4(B), the learning section setting unit 23a may set a section from the point A to the point B to a section for calculating a driven distance, and a section from the point A to the point C to a section for calculating an angular variation. In this case, it is sufficient that the learning section setting unit 23a instructs the driven distance calculating units 13a and 23b to pass a driven distance between the point A and the point B and an angular variation between the point A and the point C to the learning unit 13b.

As described above, a section with fewer changes in vehicle speed like a straight section is set to a section for calculating a driven distance, so that it is possible to enhance the accuracy of calculating a driven distance. It is noted that the learning section setting unit 23a may set a section where a change in vehicle speed ranges within a predetermined range to a section for calculating a driven distance.

The driven distance calculating unit 23b is a processing unit that calculates a driven distance by the vehicle (the second driven distance) in a learning section based on GPS information provided from GPS satellites. More specifically, in the case of receiving an instruction to start learning from the learning section setting unit 23a, the driven distance calculating unit 23b starts to acquire GPS information from the GPS information acquiring unit 22 and takes the history of GPS information until the driven distance calculating unit 23b receives an instruction to end learning from the learning section setting unit 23a. In the case of receiving the instruction to end learning from the learning section setting unit 23a, the driven distance calculating unit 23b then calculates a flat distance between the learning start point and the learning end point from the history of GPS information.

Moreover, the driven distance calculating unit 23b is also a processing unit that calculates an angular variation in the vehicle (the second angular variation) between the learning start point and the learning end point using this history of GPS information. For example, in the case illustrated in FIG. 4(B), the driven distance calculating unit 23b calculates an angle formed of a traveling direction from the point A to the point B and a traveling direction from the point B to the point C (an angle of a left turn at the point B) as an angular variation in the vehicle.

It is noted that such a configuration may be possible in which in the case where geographic information includes distance information and angle information for curves in scheduled traveling sections (a route), the driven distance calculating unit 23b matches GPS information with geographic information, thereby calculating the second driven distance and the second angular variation.

The vehicle location predicting unit 23c predicts a vehicle location at a point in time when a geographic image is displayed on the display unit 11 of the on-vehicle device 10, based on the vehicle speed acquired from the on-vehicle device 10 via the short range communicating unit 21, GPS information acquired by the GPS information acquiring unit 22, and the delay time information 24a and the geographic information 24b stored in the storage unit 24.

More specifically, when receiving vehicle speed from the on-vehicle device 10 via the short range communicating unit 21, the vehicle location predicting unit 23c acquires GPS information from the GPS information acquiring unit 22. Moreover, the vehicle location predicting unit 23c identifies a present vehicle location using the acquired GPS information and the geographic information 24b. The vehicle location predicting unit 23c then locates a vehicle location that advances from the present vehicle location by delay time using the vehicle speed acquired from the on-vehicle device 10 and the geographic information, and passes the located vehicle location to the geographic image generating unit 23d.

Furthermore, the vehicle location predicting unit 23c further predicts the orientation of the vehicle at the predicted vehicle location using the angular velocity received from the on-vehicle device 10 via the short range communicating unit 21. More specifically, the vehicle location predicting unit 23c determines the orientation of the vehicle that advances from the present vehicle location by delay time using the angular velocity acquired from the on-vehicle device 10 and the geographic information, and passes the determined orientation of the vehicle to the geographic image generating unit 23d.

It is noted that such a configuration may be possible in which the geographic information 24b is stored in the storage unit 24 beforehand, or only necessary geographic information is appropriately downloaded from a service center having geographic information.

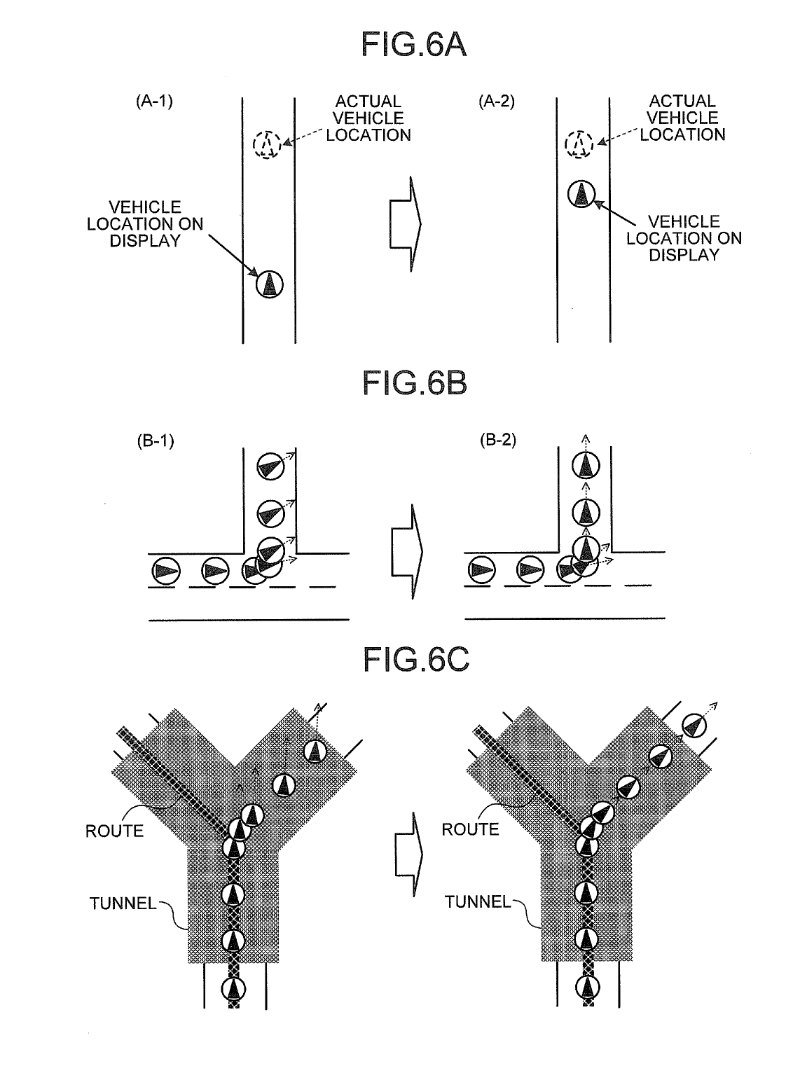

The geographic image generating unit 23d is a processing unit that generates a geographic image corresponding to the vehicle location and the orientation of the vehicle acquired from the vehicle location predicting unit 23c using the geographic information 24b stored in the storage unit 24, and sends the generated geographic image to the on-vehicle device 10. As described above, the geographic image generating unit 23d generates geographic information corresponding to the vehicle location predicted by the vehicle location predicting unit 23c, so that it is possible to reduce a display lag between the predicted vehicle location and the actual vehicle location. Here, this effect will be described with reference to FIGS. 6(A) to 6(C). FIGS. 6(A) to 6(C) illustrate diagrams for explaining the effect made by the navigation system according to this embodiment.

As illustrated in FIG. 6(A), in a conventional navigation method, since only a preset vehicle speed calculation coefficient is used to calculate vehicle speed, the calculated vehicle speed lags behind the actual vehicle speed in the case where the vehicle state is changed, causing a possibility to reduce the predictability of a vehicle location (see (A-1) in FIG. 6(A)). On the other hand, in the navigation system according to this embodiment, since vehicle speed is calculated using the vehicle speed calculation coefficient corresponding to a change in the state of the vehicle, a lag between the calculated vehicle speed and the actual vehicle speed is made small. Consequently, it is possible to more surely reduce a display lag between the calculated vehicle location and the actual vehicle location (see (A-2) in FIG. 6(A)).

Moreover, as illustrated in FIG. 6(B), since it is likely that the gyro sensor is reduced in the accuracy of detecting the orientation of the vehicle due to a long time use, the orientation of the vehicle is sometimes displayed incorrectly when the vehicle changes directions (see (B-1) in FIG. 6(B)). On the other hand, in the navigation system according to this embodiment, since the angular velocity is calculated using the angular velocity calculation coefficient corresponding to a change in the state of the vehicle (that is, a change in the performance of the gyro sensor), the orientation of the vehicle can be displayed more accurately (see (B-2) in FIG. 6(B)).

It is noted that as illustrated in FIG. 6(C), since a vehicle location is predicted using only vehicle speed and angular velocity in such places where GPS information cannot be acquired as in a tunnel or a building, it becomes more important that the vehicle speed calculation coefficient and the angular velocity calculation coefficient are corrected as matched with the vehicle state like this embodiment. Thus, for example, it can be more accurately predicted which direction the vehicle goes to at a branch point in a tunnel, so that it is possible to determine for a shorter time whether the vehicle deviates from a route.

It is noted that such a configuration may be possible in which the geographic image generating unit 23d sends information such as the vehicle location and the orientation of the vehicle acquired from the vehicle location predicting unit 23c to a service center, the service center is caused to generate a geographic image corresponding to these items of information, and the geographic image generating unit 23d acquires the geographic information generated at the service center.

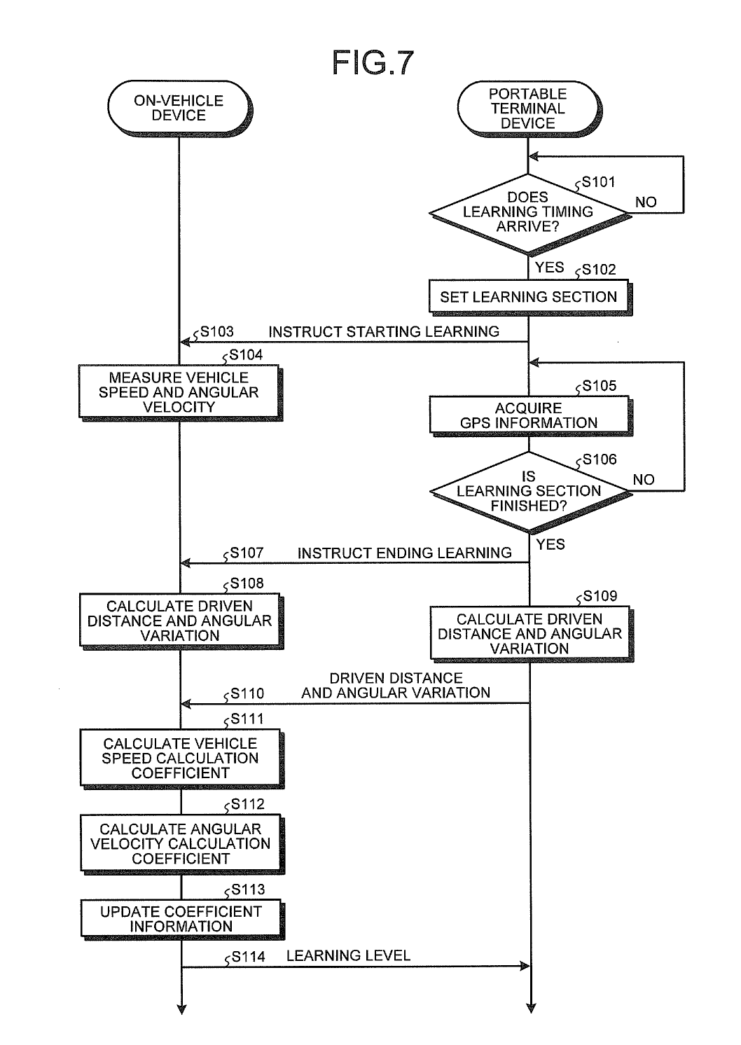

Next, process procedures performed between the on-vehicle device 10 and the portable terminal device 20 will be described. First, process procedures between the on-vehicle device and the portable terminal device in the case of learning the vehicle speed calculation coefficient and the angular velocity calculation coefficient will be described. FIG. 7 is a sequence diagram illustrating process procedures between the on-vehicle device and the portable terminal device. It is noted that FIG. 7 illustrates the process procedures in the case of learning the vehicle speed calculation coefficient and the angular velocity calculation coefficient.

As illustrated in FIG. 7, the learning section setting unit 23a of the portable terminal device 20 determines whether learning timing arrives (Step S101). In the case of determining that learning timing arrives (Yes in Step S101), the learning section setting unit 23a sets an optimum learning section based on geographic information and GPS information (Step S102).

Subsequently, when the vehicle arrives at the starting point of the learning section, the learning section setting unit 23a sends an instruction to start learning to the on-vehicle device 10 via the short range communicating unit 21 (Step S103), and instructs the driven distance calculating unit 23b of the portable terminal device 20 to start learning.

Subsequently, in the on-vehicle device 10, when receiving the instruction to start learning from the portable terminal device 20 via the short range communicating unit 12, the driven distance calculating unit 13a starts to measure vehicle speed based on the number of vehicle speed pulses outputted and measure angular velocity based on the output value of the gyro sensor (Step S104). Moreover, in the portable terminal device 20, when receiving the instruction to start learning from the learning section setting unit 23a, the driven distance calculating unit 23b starts to acquire GPS information (Step S105).

Subsequently, in the portable terminal device 20, the learning section setting unit 23a determines whether the learning section is finished (Step S106). This determination is made whether the vehicle arrives at the end point of the learning section. In this processing, when it is determined that the learning section is finished (Yes in Step S106), the learning section setting unit 23a sends an instruction to end learning to the on-vehicle device 10 via the short range communicating unit 21 (Step S107), and instructs the driven distance calculating unit 23b of the portable terminal device 20 to end learning. It is noted that in the case where the learning section is not finished (No in Step S106), the learning section setting unit 23a moves processing to Step S105, and keeps acquiring GPS information.

Subsequently, in the on-vehicle device 10, when receiving the instruction to start learning from the portable terminal device 20 via the short range communicating unit 12, the driven distance calculating unit 13a calculates the first driven distance and the first angular variation from the measured vehicle speed and angular velocity in the learning section (Step S108).

Moreover, in the portable terminal device 20, the driven distance calculating unit 23b calculates the second driven distance and the second angular velocity based on the GPS information acquired in Step S105 and the geographic information (Step S109). Furthermore, the driven distance calculating unit 23b sends the calculated second driven distance and the calculated second angular velocity to the on-vehicle device 10 (Step S110).

Subsequently, in the on-vehicle device 10, the learning unit 13b calculates the vehicle speed calculation coefficient based on the result of comparing the first driven distance with the second driven distance (Step S111), and calculates the angular velocity calculation coefficient based on the first angular variation and the second angular variation (Step S112). The learning unit 13b then updates the coefficient information 14a stored in the storage unit 14 by the calculated vehicle speed calculation coefficient and the calculated angular velocity calculation coefficient (Step S113), and sends a learning level to the portable terminal device 20 (Step S114), and ends processing.

It is noted that the on-vehicle device 10 and the portable terminal device 20 repeat processing in Steps S102 to S114 until the learning level sent in Step S114 reaches the level “4”.

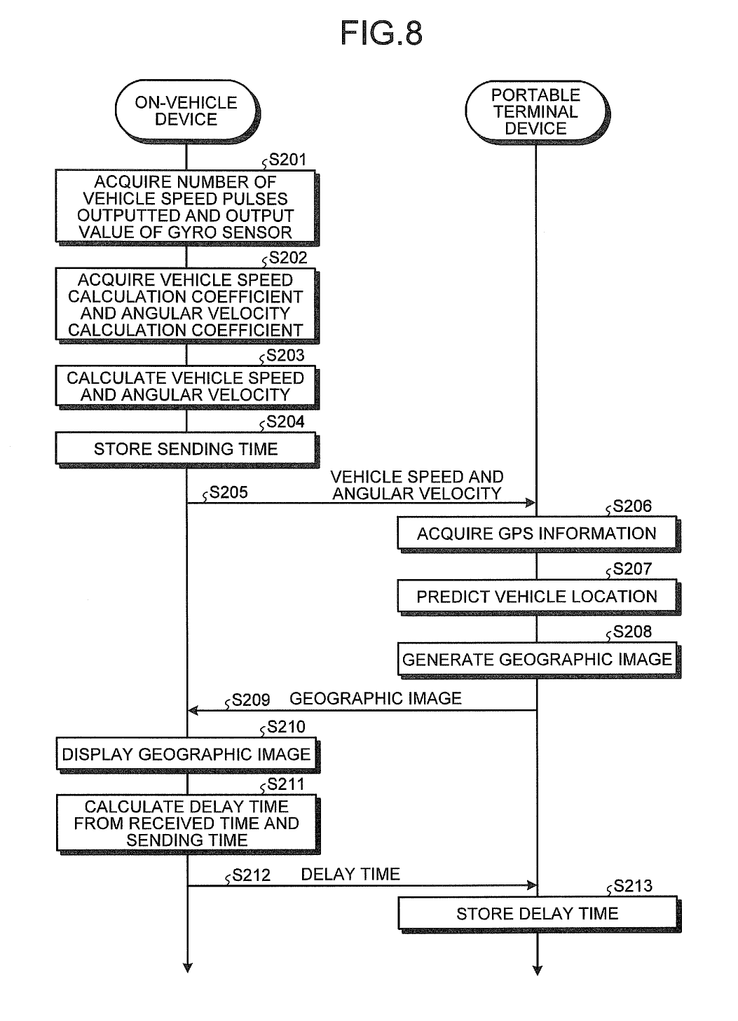

Next, process procedures between the on-vehicle device and the portable terminal device will be described in the case of predicting a vehicle location using vehicle speed and angular velocity for displaying a geographic image corresponding to the predicted vehicle location. FIG. 8 is a sequence diagram illustrating different process procedures between the on-vehicle device and the portable terminal device. It is noted that FIG. 8 illustrates the process procedures in the case of predicting a vehicle location using vehicle speed and angular velocity for displaying a geographic image corresponding to the predicted vehicle location.

As illustrated in FIG. 8, in the on-vehicle device 10, the velocity calculating unit 13c acquires the number of vehicle speed pulses outputted and the output value of the gyro sensor from the vehicle (Step S201), and acquires the vehicle speed calculation coefficient and the angular velocity calculation coefficient from the storage unit 14 (Step S202). Subsequently, the velocity calculating unit 13c calculates vehicle speed by multiplying the number of vehicle speed pulses outputted by the vehicle speed calculation coefficient, and calculates angular velocity by multiplying the output value of the gyro sensor by the angular velocity calculation coefficient (Step S203).

Subsequently, the velocity calculating unit 13c stores sending time (Step S204), and then sends the vehicle speed and the calculated angular velocity calculated in Step S203 to the portable terminal device 20 (Step S205).

On the other hand, in the portable terminal device 20, the vehicle location predicting unit 23c acquires the vehicle speed and the angular velocity from the on-vehicle device 10, and then acquires GPS information from the GPS information acquiring unit 22. (Step S206). The vehicle location predicting unit 23c then predicts a vehicle location based on the vehicle speed and the angular velocity acquired in Step S205, the GPS information acquired in Step S206, and the delay time information 24a and the geographic information 24b stored in the storage unit 24 (Step S207).

Subsequently, in the portable terminal device 20, the geographic image generating unit 23d generates a geographic image corresponding to the vehicle location predicted in Step S207 (Step S208), and sends the generated geographic image to the on-vehicle device 10 (Step S209).

Subsequently, in the on-vehicle device 10, the display processing unit 13d displays the geographic image acquired from the portable terminal device 20 on the display unit 11 (Step S210). Moreover, in the on-vehicle device 10, the learning unit 13b calculates a difference between the time at which the geographic information is received in Step S209 and the sending time stored in Step S204 as delay time (Step S211), and sends the calculated delay time to the portable terminal device 20 (Step S212). In the portable terminal device 20, the control unit 23 then stores the delay time acquired from the on-vehicle device 10 as the delay time information 24a in the storage unit 24 (Step S213), and ends processing.

As described above, in this embodiment, the driven distance calculating unit of the on-vehicle device calculates the first driven distance in a predetermined section based on vehicle speed calculated using vehicle speed pulses outputted from the vehicle and the vehicle speed calculation coefficient, the driven distance calculating unit of the portable terminal device calculates the second driven distance of the vehicle in the predetermined section based on location information provided from global navigation satellites, the learning unit of the on-vehicle device corrects the vehicle speed calculation coefficient based on the result of comparing the first driven distance with the second driven distance, and the vehicle location predicting unit of the portable terminal device predicts a vehicle location based on the vehicle speed calculated using the vehicle speed pulses and the corrected vehicle speed calculation coefficient.

Therefore, the vehicle location is predicted using the corrected vehicle speed calculation coefficient corresponding to a change in the state of the vehicle, so that it is possible to reduce a lag between a vehicle location displayed by the on-vehicle device and an actual vehicle location while preventing a reduction in the predictability of a vehicle location due to a change in the state of a vehicle.

### INDUSTRIAL APPLICABILITY

As described above, the navigation system and the on-vehicle device according to the present invention are useful in the case where it is desired to reduce a lag between a vehicle location displayed by the on-vehicle device and an actual vehicle location while preventing a reduction in the predictability of a vehicle location due to a change in the state of a vehicle, and particularly suited in the case where it is desired to provide navigation services to offer location information about a vehicle using the on-vehicle device and a portable terminal device.

### REFERENCE SIGNS LIST

10 On-vehicle device
11 Display unit
12 Short range communicating unit
13 Control unit
13a Driven distance calculating unit
13b Learning unit
13c Velocity calculating unit
13d Display processing unit
14 Storage unit
14a Coefficient information
20 Portable terminal device
21 Short range communicating unit
22 GPS information acquiring unit
23 Control unit
23a Learning section setting unit
23b Driven distance calculating unit
23c Vehicle location predicting unit
23d Geographic image generating unit
24 Storage unit
24a Delay time information
24b Geographic information

1. A navigation system that provides location information about a vehicle using an on-vehicle device and a portable terminal device, the navigation system comprising:
a first calculating unit configured to calculate a driven distance in a predetermined section based on vehicle speed calculated using a vehicle speed pulse outputted from a vehicle and a vehicle speed calculation coefficient;
a second calculating unit configured to calculate a driven distance by the vehicle in the predetermined section based on location information provided from a global navigation satellite;
a correcting unit configured to correct the vehicle speed calculation coefficient based on a result of comparing the driven distance calculated by the first calculating unit with the driven distance calculated by the second calculating unit; and
a predicting unit configured to predict a vehicle location based on the vehicle speed calculated using the vehicle speed pulse and the vehicle speed calculation coefficient corrected by the correcting unit.

2. The navigation system according to claim 1, wherein:
the first calculating unit calculates an angular variation in a predetermined section based on angular velocity calculated using an output value of a gyro sensor mounted on the vehicle and an angular velocity calculation coefficient;
the second calculating unit calculates an angular variation in the vehicle in the predetermined section based on location information provided from the global navigation satellite;
the correcting unit corrects the angular velocity calculation coefficient based on a result of comparing the angular variation calculated by the first calculating unit with the angular variation calculated by the second calculating unit; and
the predicting unit further predicts an orientation of the vehicle at the predicted vehicle location based on an angular velocity calculated using the output value of the gyro sensor and the angular velocity calculation coefficient corrected by the correcting unit.

3. The navigation system according to claim 2,
wherein the correcting unit corrects the angular velocity calculation coefficient based on the angular variations calculated by the first calculating unit and the second calculating unit as the predetermined section is a section where an angle in a yaw direction is changed only in one direction.

4. The navigation system according to claim 1,
wherein the correcting unit corrects the vehicle speed calculation coefficient or the angular velocity calculation coefficient based on the driven distances or the angular variations calculated by the first calculating unit and the second calculating unit as the predetermined section is a section on an expressway.

5. The navigation system according to claim 1,
wherein the correcting unit corrects the vehicle speed calculation coefficient or the angular velocity calculation coefficient based on the driven distances or the angular variations calculated by the first calculating unit and the second calculating unit as the predetermined section is a section where a tilt angle to a horizontal plane ranges within a predetermined threshold.

6. An on-vehicle device that provides location information about a vehicle in linking with a portable terminal device, the on-vehicle device comprising:
a calculating unit configured to calculate a driven distance in a predetermined section based on vehicle speed calculated using a vehicle speed pulse outputted from a vehicle and a vehicle speed calculation coefficient;
a correcting unit configured to correct the vehicle speed calculation coefficient based on a result of comparing the driven distance calculated by the calculating unit with a driven distance by the vehicle in the predetermined section calculated by the portable terminal device based on location information provided from a global navigation satellite; and
a sending unit configured to send the vehicle speed calculation coefficient corrected by the correcting unit to the portable terminal device.
